(19) United States
(12) Patent Application Publication
(10) Pub. No.: US 2012/0101873 A1
(43) Pub. Date: Apr. 26, 2012

(54) METHOD AND APPARATUS FOR DYNAMIC COMMUNICATION-BASED AGENT SKILL ASSESSMENT

(75) Inventors: Michael Paul Lepore, Marlborough, MA (US); Tod Famous, Ayer, MA (US); John Joseph Hernandez, San Jose, CA (US); Ruchi Gupta, Sunnyvale, CA (US)

(73) Assignee: CISCO TECHNOLOGY, INC., San Jose, CA (US)

(21) Appl. No.: 12/912,406

(22) Filed: Oct. 26, 2010

(51) Int. Cl. G06F 17/30

(52) U.S. Cl. 705/7.42

(57) ABSTRACT

In one embodiment, a method includes obtaining information relating to an interaction between an agent associated with a contact center and a customer. The information includes an indicator of a satisfaction level of the customer and/or the agent. The method also includes providing at least the indicator to an expertise assessment arrangement and developing a characterization of an expertise of the agent using the expertise assessment arrangement. Developing the characterization of the expertise includes using the indicator.

### TECHNICAL FIELD

The disclosure relates generally to communications networks and, more specifically, to improving the ability to accurately characterize contact center agents as having particular skills.

### BACKGROUND

Contact centers, or customer interaction centers, generally manage customer contacts. Agents of the contact centers interface substantially directly with customers to exchange information. Often, contact centers may be, or may include, call centers that are arranged to provide service to customers, e.g., callers.

A contact center would typically be provided with special software that would allow contact information to be routed to appropriate people, contacts to be tracked, and data to be gathered. A contact center is considered to be an important element in multichannel marketing.

Within contact centers, pre-populated skill profiles are associated with agents. Agents may be assigned particular skills, or may otherwise be characterized as having particular skills, by an administrator of the call center. The assigned skills are placed in skill profiles associated with agents such that calls from customers may be routed to agents with skill profiles that appear to be appropriate for providing customers with specific assistance.

The substantially manual assignment of skills to agents by administrators is cumbersome and inefficient. In particular, maintaining and updating skill assignments is often both time-consuming and inaccurate. Inaccuracies may arise, for example, when a particular agent handles a substantial number of communications in a particular area and is identified as possessing skill in the area, but is in reality not particularly well-qualified in the area.

### BRIEF DESCRIPTION OF THE DRAWINGS

The disclosure will be readily understood by the following detailed description in conjunction with the accompanying drawings in which:

FIG. 1 is a process flow diagram which illustrates a method of obtaining tags in accordance with an embodiment.

FIG. 2 is a diagrammatic representation of a contact center processing arrangement in accordance with an embodiment.

FIG. 3 is a diagrammatic representation of a system in which an analytic module is arranged to update an agent skill level based on information gathered during an interaction between the agent and a caller in accordance with an embodiment.

FIG. 4 is a block diagram representation of an analytic module in accordance with an embodiment.

FIG. 5 is a process flow diagram which illustrates a method of tagging in accordance with an embodiment.

### DESCRIPTION OF EXAMPLE EMBODIMENTS

### General Overview

According to one aspect, a method includes obtaining information relating to an interaction between an agent associated with a contact center and a customer. The information includes an indicator of a satisfaction level of at least one of the agent and the customer. The method also includes providing at least the indicator to an expertise assessment arrangement and developing a characterization of an expertise of the agent using the expertise assessment arrangement. Developing the characterization of the expertise includes using the indicator.

### Description

Within contact centers, skill profiles associated with agent are used to identify an appropriate agent to provide service to a customer. When an agent with a high skill level, e.g., expertise, in an area that relates to information that is appropriate to a customer is selected to interact with the customer, the likelihood that the customer will have a satisfactory experience is increased. Thus, the ability to accurately assess the skill level of an agent is crucial.

By using information relating to actual interactions involving an agent to assess the skill level of the agent, the accuracy of the skill level attributed to the agent is enhanced. For example, the experience of a customer who is interacting with, or has interacted with, an agent may be used to assess the skill level of the agent. It should be appreciated that the experience of the agent may also be used to assess the skill level of the agent. If the experience of the customer is satisfactory, then an appropriate skill level of the agent may be adjudged as being relatively high, or the agent may be assess as possessing a particular skill. Alternatively, if the experience of the customer is unsatisfactory, then an appropriate skill level of an agent may be adjudged as being relatively low, or the agent may be assessed as not possessing a particular skill.

A tagging system may be used to associate skills with an agent. Interactions, e.g., conversations, may be sniffed by a tagging system to identify key words and/or phrases. The key words and/or phrases may be used by the tagging system to essentially create a tag that may be associated with the agent. Such a tag is intended to be a reflection of the skill level, e.g., expertise, possessed by the agent. In one embodiment, the experience of a customer who interacts with, or interacted with, an agent may be accounted for in creating a tag. In general, tags may be augmented and/or created, e.g., dynamically augmented and/or created, while a customer and an agent are interacting, based on the experience of the customer. In another embodiment, in addition to the experience of the customer, the experience of the agent may be accounted for in creating a tag.

By way of example, if a customer calls an agent at a contact center to discuss “Unified Contact Center Enterprise,” a tag that identifies “Unified Contact Center Enterprise” may be created. In one embodiment, if the customer has a satisfactory experience in his interaction with the agent, then the agent may be identified as being skilled in “Unified Contact Center Enterprise,” and the tag that identifies “Unified Contact Center Enterprise” may be associated with the agent. On the other hand, if the customer has an unsatisfactory experience in his interaction with the agent, then the agent may be identified as not being skilled in “Unified Contact Center Enterprise.” The experience of the agent may also be accounted for. For example, if there is little confidence shown in the tone used by the agent, the agent may be identified as having an unsatisfactory experience, and this lack of satisfaction may be used in identifying the skills of the agent.

Effectively linking the communication experience of a customer and an agent to the creation, e.g., the dynamic creation, of tags which are arranged to define skills of the agent allows the agent to be relatively accurately tagged based on his or her expertise. Rather than basing tags substantially only on words or phrases used during an interaction between a customer and an agent, whether those words or phrases were used during a satisfactory experience or an unsatisfactory experience is accounted for.

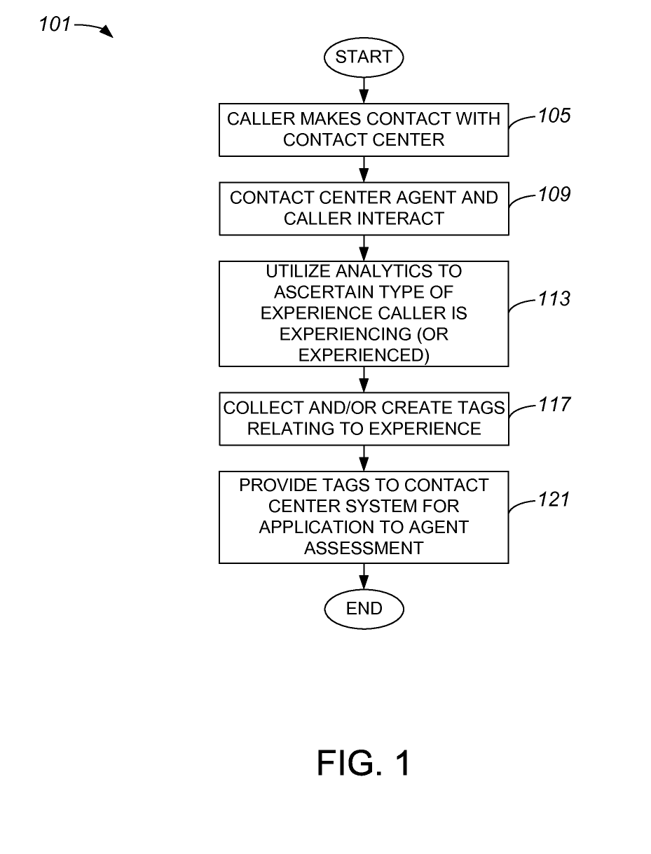

Referring initially to FIG. 1, a process of obtaining tags in accordance with an embodiment will be described. A process 101 of obtaining tags begins at step 105 in which a caller or, more generally, a customer, makes contact with a contact center. In one embodiment, the caller may place a phone call to or receive a phone call from an agent at a contact center, e.g., a contact center agent. It should be appreciated, however, that although a caller making contact with a contact center by placing a call to or receiving a call from the contact is described, a caller is not limited to making contact with a contact center through a call. A caller may make contact with a call center or, more generally, a contact center using any suitable method including, but not limited to including, placing or receiving a call, sending or receiving an email, sending or receiving a text message, initiating or participating in a video conference, initiating or participating in a web chat, and/or sending or receiving an instant message (IM). Further, a contact center may generally be any establishment from which a caller requests and/or obtains assistant, e.g., a call center.

Once the caller makes contact with a contact center, the caller interacts with a contact center agent in step 109. When a caller interacts with a contact center agent, the caller and the contact center agent generally communicate back and forth. While the caller and the contact center agent interact, a monitoring function of the contact center may generally monitor, e.g., capture or record, the interaction. Monitoring the interaction may include, but is not limited to including, monitoring the vocabulary used in the interaction, monitoring the phrases used in the interaction, and/or monitoring the emotion associated with the interaction. Monitoring the emotion associated with the interaction may involve determining if a caller sounds satisfied or unsatisfied, or in the event that the caller and the contact center agent are participating in a video conference, determining if the facial expression of the caller indicates whether the caller is satisfied or unsatisfied. It should be appreciated that although monitoring the interaction has generally been described as monitoring the customer, monitoring the interaction may generally also include monitoring the agent.

In step 113, analytics are used to ascertain the type of experience the caller is experiencing or, if the interaction between the caller and the contact center agent has concluded, ascertaining the type of experience the caller experienced. Generally, information obtained from a monitoring function of a contact center may be analyzed to determine whether a caller had a satisfactory experience, e.g., a positive or non-negative experience, or a negative experience in his interaction with the contact center agent. By way of example, if a caller uses vocabulary that indicates satisfaction, and portrays positive emotion, then analytics may ascertain that the caller is having a satisfactory experience. When the interaction between the caller and the contact center agent has concluded, ascertaining the type of experience the caller experienced may include analyzing a post-interaction survey completed by the caller to determine an overall satisfaction level of the caller.

From step 113, process flow moves to step 117 in which tags are collected and/or created relating to the experience the caller had with the contact center agent. Tags are generally collected and associated with a contact center agent to identify expertise the contact center agent possesses. For example, a tag of “telepresence” associated with a contact center agent may indicate that the contact center agent has expertise in the area of telepresence. The experience of the caller may be accounted for in collecting and/or creating tags by collecting and/or creating a tag only when the caller had a non-negative experience. By way of example, although the term “telepresence” may arise repeatedly during the interaction between the caller and the contact center agent, a tag may be collected and/or created substantially only when the caller had a satisfactory experience. If the caller had a negative experience, even though the term “telepresence” arises repeatedly during the interaction, a tag may not be collected and/or created.

After tags are collected and/or created, the tags are provided to the contact center system in step 121 for use in assessing the expertise associated with the contact center agent. It should be appreciated that if the contact center system collects and/or creates the tags, then providing tags to the contact center system may involve providing tags to the appropriate module in the contact center system such that the tags may be further developed, e.g., modified or updated. Such an appropriate module may be a tagging module or an expertise assessment module. Assessing the expertise associated with the contact center agent may include, but is not limited to including, identifying the contact center agent as being an expert or effectively identifying the contact center agent as not being an expert. Upon providing the tags to the contact center system for application to the contact center agent, the process of obtaining tags is completed.

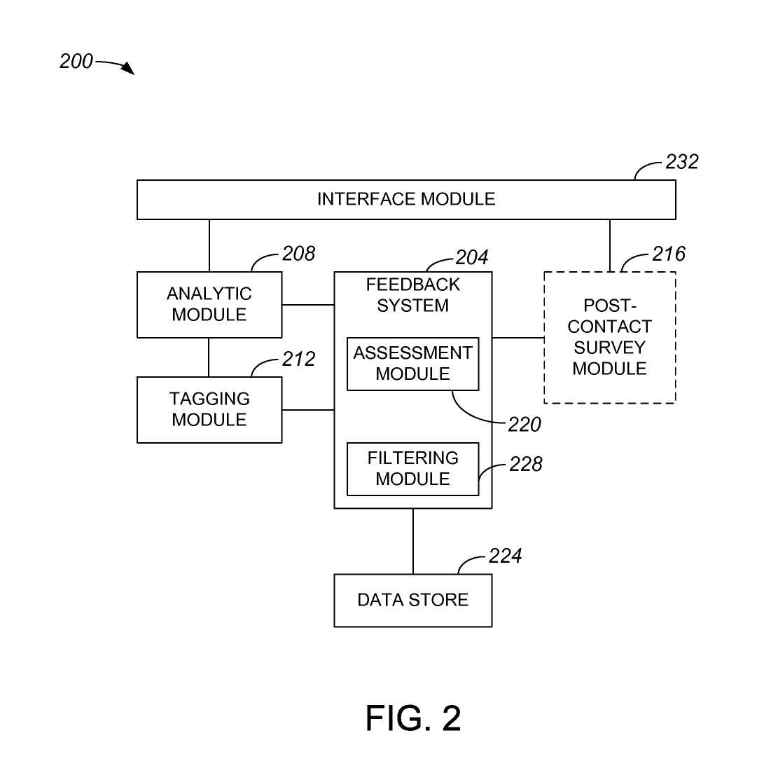

A contact center generally includes, among other systems, a processing system that is configured to collect information that is to be used to assess the skill level, or the expertise, of an agent. It should be appreciated that the information collected includes information relating to how a caller perceives, or perceived, his or her interaction with the agent. FIG. 2 is a diagrammatic representation of a contact center processing system in accordance with an embodiment. A contact center processing system 200 includes an interface module 232 arranged to enable a caller to interact with a contact center agent.

An analytic module 208 is arranged to monitor an interaction in real-time, or analyze an interaction after the interaction is completed. Analytic module 208 implements or runs analytics, e.g., speech analytics, to extract information from an interaction to assess the experience of the caller as well as the experience of the agent. Analytics are not limited to speech analytics and may also include, but are not limited to including, facial recognition analytics.

Analytic module 208 may also, in one embodiment, cooperate with a tagging module 212 to extract key words and/or phrases from the interaction. As will be understood by those skilled in the art, tagging module 212 may also operate substantially independently of analytic module 208 to identify key words and/or phrases that are, or may be, used as tags.

A feedback system 204 includes an assessment module 220 and a filtering module 228. Feedback system 204 is generally configured to use information from analytic module 208, tagging module 212, and an optional post-contact survey module 216 to identify or otherwise determine suitable tags for an agent, e.g., tags which accurately identify skills the agent possesses. Post-contact survey module 216 generally obtains results of a post-contact survey provided to a caller in order to obtain an assessment of his or her experience with an interaction after the interaction has been completed. In such a survey, a caller may directly rate his or her experience with an interaction, and directly provide information relating to his or her perception of the interaction. The information provided may effectively be a communications experience index. Such information may be provided directly from post-contact survey module 216 to feedback system 204, or may be provided to feedback system 204 through analytic module 208.

Assessment module 220 may utilize information obtained from analytic module 208, tagging module 212, and/or post-contact survey module 216 to identify and/or create tags which are appropriate for a particular agent. For example, if tagging module 212 sniffs an interaction and identifies a tag, and analytic module 208 determines that a caller had a highly satisfactory experience during the interaction, the tag may be determined to be appropriate for the particular agent. Such a tag may be associated with the particular agent dynamically, i.e., while the interaction is ongoing. Assessment module 208 may also remove tags which were previously associated with an agent, based upon information obtained from analytic module 208, tagging module 212, and/or post-contact survey module 216. By way of example, if tagging module 212 sniffs an interaction and identifies a tag that was already associated with an agent, and analytic module 208 determines that a caller had an unsatisfactory experience during the interaction, the tag may be disassociated from the particular agent. In other words, an agent who was previously identified as having a particular skill may no longer be identified as having that particular skill if a caller had an unsatisfactory experience during an interaction with the agent. It should be appreciated that an unsatisfactory experience of the agent may also factor into identifying whether to dissociate a tag from the agent.

Filtering module 228 may cooperate with assessment module 220 to determine when tags should be added, removed, and/or modified. For example, filtering module 228 may implement policies which specify when it is appropriate to add, remove, and/or modify tags. In one embodiment, filtering module 228 may specify a policy that ages out older caller experiences when determining whether to add or remove a tag, and weights recent caller experiences more heavily in determining whether to add or remove a tag.

A data store 224 may store skill profiles that identify tags associated with agents. Once tags are associated with agents, skill profiles may be formed to identify the tags associated with particular agents. In general, data store 224 may be a database. Feedback system 204 may obtain the skill profiles form data store 224, and may provide skill profiles to data store 224 for storage.

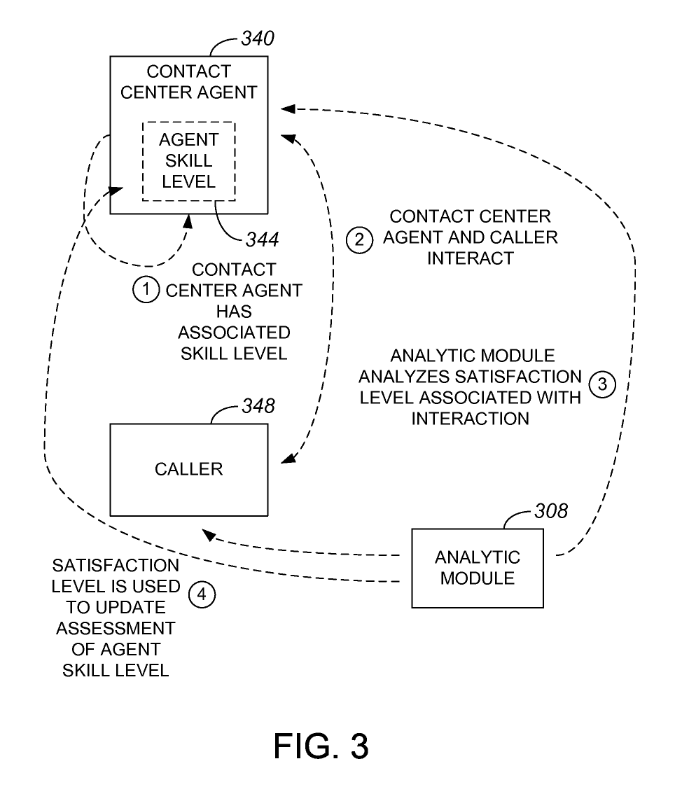

FIG. 3 is a diagrammatic representation of a system in which an analytic module is arranged to update an agent skill level based on information gathered during an interaction between the agent and a caller in accordance with an embodiment. A contact center agent 340 has an associated skill level 344. When contact center agent 340 interacts with caller 348, an analytic module 308 may either monitor the interaction between contact center agent 340 and caller 348 in real-time, or assess the interaction after the interaction is completed. Analytic module 308 analyzes a satisfaction level of caller 348 with respect to the interaction. The satisfaction level is then used to update skill level 344. In one embodiment, analytic module 308 provides the satisfaction level to a feedback system (not shown) that applies the satisfaction level to update skill level 344.

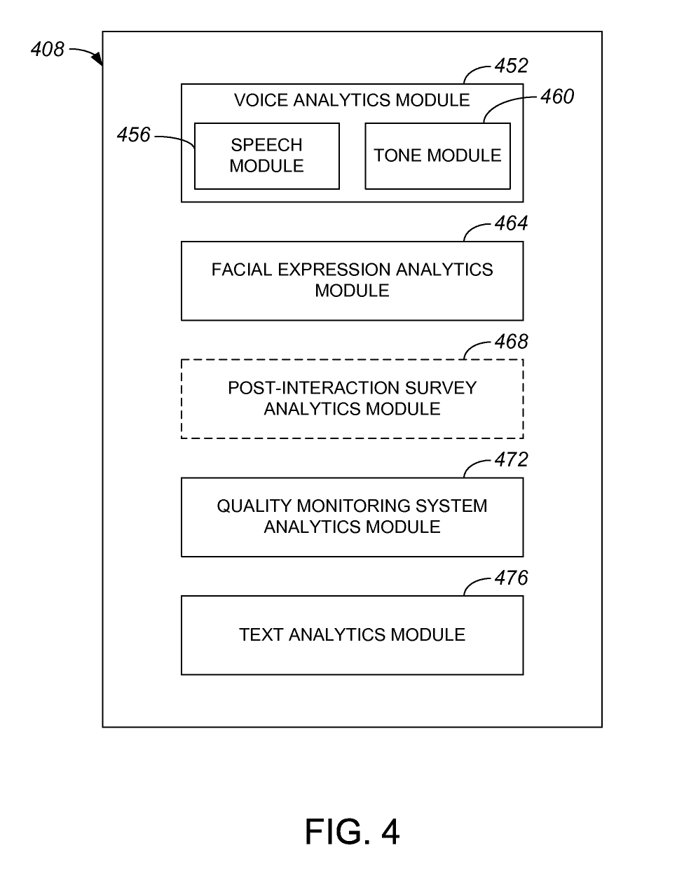

An analytic module may include a variety of different sub-modules, depending upon the type of analytics that are to be performed. With reference to FIG. 4, one analytic module will be described in accordance with an embodiment. In one embodiment, an analytic module 408 includes a voice analytics module 452, a facial expression analytics module 464, a quality monitoring system analytics module 472, a text analytics module 476, and an optional post-interaction or post-contact survey analytics module 468.

Voice analytics module 452 includes a speech module 456 and a tone module 460. In general, voice analytics module 452 may effectively analyze verbal expressions, e.g., spoken words and/or phrases, and the emotion with which the phrases are spoken. Speech module 456 may detect or sniff for words or phrases that indicate a level of satisfaction. For example, speech module 456 may identify words such as “satisfied,” “unsatisfied,” “helpful,” “unhelpful,” “good,” “bad,” “like,” “dislike,” “happy,” “unhappy,” etc. Tone module 460 may analyze an emotion or a tone with which words are spoken by a caller and, in some instances, by an agent as well. For example, a loud tone and a shrill tone may indicate dissatisfaction.

Facial expression analytics module 464 may be used when an interaction between a caller and an agent involves a teleconference or a voice chat. Facial expression analytics module 464 may analyze changes in facial expressions of the caller, and possibly the agent, to ascertain a likely level of satisfaction associated with the interaction. By way of example, if a caller is smiling during an interaction, the caller is likely having a satisfactory experience. Alternatively, of the caller is frowning, the caller is likely having an unsatisfactory experience.

Quality monitoring system analytics module 472 may be arranged to obtain information from a quality monitoring system of a contact center. The information may then be analyzed by quality monitoring system analytics module 472 to assess a level of satisfaction indicated by the information.

Text analytics module 476 is generally configured to analyze written text, such as text contained in emails or IMs. For example, text analytics module 476 may obtain words and phrases used in text and determine whether there are any words which indicate a level of satisfaction.

Post-interaction survey analytics module 468 is arranged to obtain information from a post-interaction, or post-call, survey completed by a caller after an interaction between the caller and an agent is completed. In one embodiment, post-interaction survey analytics module 468 may use information obtained from a survey to determine whether a caller was satisfied with an interaction with an agent.

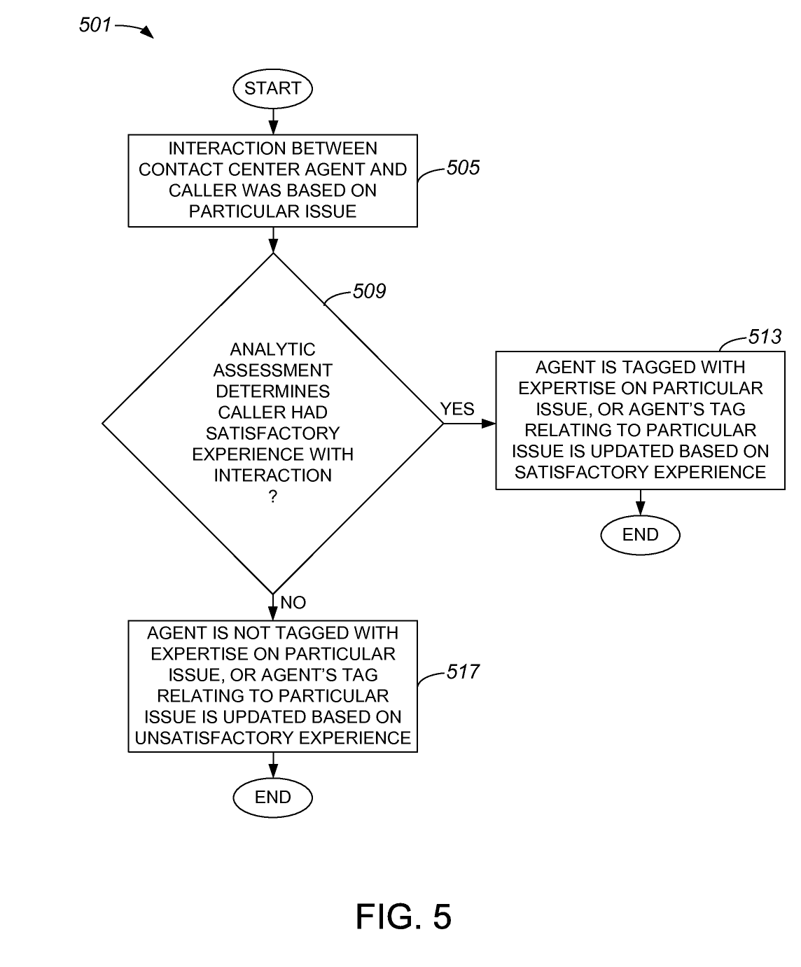

As mentioned above, information relating to a level of satisfaction experienced by a caller, as well as an agent, during an interaction with an agent may be used to assign or update tags intended to indicate skill levels of the agent. FIG. 5 is a process flow diagram which illustrates a method of tagging in accordance with an embodiment. A process 501 of tagging begins at step 505 in which an interaction between a contact center agent and a caller was based on a particular issue. The issue may be identified by a tagging system using any suitable method, e.g., the issue may relate to a keyword which arose repeatedly during the interaction.

A determination is made in step 509 as to whether an analytic assessment of the interaction determines that the caller is having, or had, a satisfactory experience during the interaction. It should be appreciated that the analytic assessment of the interaction may additionally include determining if the agent is having, or had, a satisfactory experience while interacting with the caller. A satisfactory experience may generally be, but is not limited to being, an experience that is not unsatisfactory or not negative. If it is determined that the caller is having, or had, a satisfactory experience during the interaction, the agent is tagged with expertise on the particular issue in step 513, or a pre-existing tag for the agent relating to the particular issue may be updated based on the satisfactory experience. Once the agent is tagged, or a tag of the agent is updated, the process of tagging is completed.

Alternatively, if it is determined in step 509 that the caller is not having, or did not have, a satisfactory experience during the interaction, process flow moves to step 517 in which the agent is not tagged with expertise on the particular issue, or a pre-existing tag for the agent relating to the particular issue is updated based on the unsatisfactory experience. Updating a pre-existing tag relating to the particular issue may involve disassociating the tag from the agent. The process of tagging is completed upon not tagging the agent or updating a pre-existing tag for the agent.

Although only a few embodiments have been described in this disclosure, it should be understood that the disclosure may be embodied in many other specific forms without departing from the spirit or the scope of the present disclosure. By way of example, tags associated with an agent are not limited to being created and/or updated based on the experiences of a caller. Tags may additionally be created and/or updated based on static skilling, or the assessment by parties including, but not limited to including, system administrators and agents themselves.

While tags have generally been described as becoming associated with or disassociated from an agent based on the experience a caller had during an interaction with the agent, tags are not limited to becoming associated with or disassociated from an agent. In one embodiment, where tags have a strength associated therewith, the strength of a particular tag may be adjusted based upon the experience a caller had during an interaction with an agent. For instance, if a tag associated with an agent indicates a relatively high skill level, the tag may be adjusted to indicate a lower skill level as a result of a caller having a negative experience.

Thresholds may be implemented with respect to the implementation of tags. By way of example, when a tag has a strength associated therewith, the tag may remain associated with an agent until the strength is determined to be below a threshold level. Similarly, a tag may be provisionally linked with, but not associated with, an agent until such time as the strength associated with the tag exceeds a particular threshold, at which point the tag becomes associated with the agent. That is, a tag may be linked with an agent such that the tag may be updated based upon the experiences of users with the agent, but the tag may not actually identify a skill the agent possesses until the strength of the tag exceeds a particular threshold.

In lieu of, or in addition to, analyzing words, phrases, and emotion in assessing a satisfaction level relating to an interaction, the overall tenor of an interaction may be assessed. What a caller says in response to a query from an agent may factor into a determination of a satisfaction level. For instance, if an agent asks “Have I satisfactorily answered all your questions” and a caller answers “Yes,” then an analytic module may determine that the caller is satisfied with his or her interaction with the agent.

Voice recognition functionality may generally be provided with an analytics module, as well as a tagging module, such that spoken words and phrases may be identified. Alternatively, however, it should be appreciated that a substantially separate voice recognition module may be arranged to interface with an analytics module and a tagging module.

The embodiments may be implemented as hardware and/or software logic embodied in a tangible medium that, when executed, is operable to perform the various methods and processes described above. That is, the logic may be embodied as physical arrangements, modules, and/or components. A tangible medium may be substantially any suitable physical, computer-readable medium that is capable of storing logic which may be executed, e.g., by a computing system, to perform methods and functions associated with the embodiments. In one embodiment, the logic may generally be executable logic that is executed by a computer processor to perform methods and functions associated with the embodiments. Such computer-readable media may include, but are not limited to including, physical storage and/or memory devices. Executable logic may include code devices, computer program code, and/or executable computer commands or instructions.

It should be appreciated that a computer-readable medium, or a machine-readable medium, may include transitory embodiments and/or non-transitory embodiments, e.g., signals or signals embodied in carrier waves. That is, a computer-readable medium may be associated with non-transitory tangible media and/or transitory propagating signals.

The steps associated with the methods of the present disclosure may vary widely. Steps may be added, removed, altered, combined, and reordered without departing from the spirit of the scope of the present disclosure. Therefore, the present examples are to be considered as illustrative and not restrictive, and the examples is not to be limited to the details given herein, but may be modified within the scope of the appended claims.

What is claimed is:

1. A method comprising:
obtaining information relating to an interaction between an agent associated with a contact center and a customer, the information including an indicator of a satisfaction level of at least one of the agent and the customer;
providing at least the indicator to an expertise assessment arrangement; and
developing a characterization of an expertise of the agent using the expertise assessment arrangement, wherein developing the characterization of the expertise includes using the indicator.

2. The method of claim 1 wherein developing the characterization of the expertise includes creating a tag arranged to identify the expertise.

3. The method of claim 2 further including:
associating the tag with the agent when the satisfaction level indicates that the customer is satisfied.

4. The method of claim 1 wherein developing the characterization of the expertise includes updating a tag arranged to identify the expertise.

5. The method of claim 1 wherein obtaining the information relating to the interaction includes monitoring the interaction substantially in real-time while the interaction is ongoing.

6. The method of claim 5 wherein obtaining the information relating to the interaction further includes obtaining a perception from the customer after the interaction is completed and creating the indicator, the perception being related to the interaction.

7. The method of claim 6 wherein creating the indicator includes analyzing the perception.

8. The method of claim 1 wherein obtaining the information relating to the interaction includes implementing speech analytics on the interaction.

9. The method of claim 8 wherein the information includes an indication of the characterization.

10. An apparatus comprising:
means for obtaining information relating to an interaction between an agent associated with a contact center and a customer, the information including an indicator of a satisfaction level of at least one of the customer and the agent;
means for providing at least the indicator to an expertise assessment arrangement; and
means for developing a characterization of an expertise of the agent using the expertise assessment arrangement, wherein the means for developing the characterization of the expertise include means for using the indicator.

11. A computer-readable medium comprising computer program code, the computer program code, when executed, configured to:
obtain information relating to an interaction between an agent associated with a contact center and a customer, the information including an indicator of a satisfaction level of at least one of the customer and the agent;
provide at least the indicator to an expertise assessment arrangement; and
develop a characterization of an expertise of the agent using the expertise assessment arrangement, wherein the computer program code configured to develop the characterization of the expertise includes computer code configured to use the indicator.

12. The computer-readable medium of claim 11 wherein the computer program code configured to develop the characterization of the expertise includes computer program code configured to create a tag arranged to identify the expertise.

13. The computer-readable medium of claim 12 further configured to:
associate the tag with the agent when the satisfaction level indicates that the customer is satisfied.

14. The computer-readable medium of claim 11 wherein the computer program code configured to develop the characterization of the expertise is configured to update a tag arranged to identify the expertise.

15. The computer-readable medium of claim 11 wherein the computer program code configured to obtain the information relating to the interaction is further configured to monitor the interaction substantially in real-time while the interaction is ongoing.

16. The computer-readable medium of claim 15 wherein the computer program code configured to obtain the information relating to the interaction is further configured to obtain a perception from the customer after the interaction is completed and to create the indicator, the perception being related to the interaction.

17. The computer-readable medium of claim 16 wherein the computer program code configured to create the indicator is further configured to analyze the perception.

18. The computer-readable medium of claim 11 wherein the computer program code configured to obtain the information relating to the interaction is further configured to implement speech analytics on the interaction.

19. The computer-readable medium of claim 18 wherein the information includes an indication of the characterization.

20. An apparatus comprising:
an interface module, the interface module being arranged to obtain information relating to an interaction between an agent associated with a contact center and a customer, the information including an indicator of a satisfaction level of at least one of the customer and the agent;
an expertise assessment arrangement, the expertise assessment arrangement being arranged to obtain at least the indicator, the expertise assessment arrangement further being arranged to develop a characterization of an expertise of the agent using the indicator.

21. The apparatus of claim 20 wherein the expertise assessment arrangement creates a tag arranged to identify the expertise.

22. The apparatus of claim 21 wherein the expertise assessment arrangement is further arranged to associate the tag with the agent when the satisfaction level indicates that the customer is satisfied.
